(19) United States
(12) Patent Application Publication
(10) Pub. No.: US 2014/0072254 A1
(43) Pub. Date: Mar. 13, 2014

(54) BEARING ARRANGEMENT COMPRISING A BACKUP BEARING

(71) Applicants: Michael Pausch, Dittelbrunn (DE); Wolfgang May, Kitzingen (DE); Hermann Golbach, Erlangen (DE); Peter Siebke, Erlangen (DE); Horst Masuch, Schweinfurt (DE)

(72) Inventors: Michael Pausch, Dittelbrunn (DE); Wolfgang May, Kitzingen (DE); Hermann Golbach, Erlangen (DE); Peter Siebke, Erlangen (DE); Horst Masuch, Schweinfurt (DE)

(73) Assignee: Schaeffler Technologies AG & Co., KG, Herzogenaurach (DE)

(21) Appl. No.: 14/005,925

(22) PCT Filed: Mar. 9, 2012
(86) PCT No.: PCT/EP12/54070

§ 371 Date: Nov. 22, 2013

(30) Foreign Application Priority Data
Mar. 18, 2011 (DE) 10 2011 005 761.7

(51) Int. Cl. F16C 33/58

(52) U.S. Cl. CPC F16C 33/583
USPC 384/513

(57) ABSTRACT

A bearing arrangement for mounting a shaft on a connection structure, the arrangement including a housing (1), a bearing which supports the shaft, and a backup bearing which includes a bearing ring that makes contact with the housing (1). According to the invention, the problem of providing a bearing arrangement which includes a backup bearing and allows the forces which arise in a loaded state to be better absorbed in the backup bearing, is solved by a slit (9) being provided in the housing (1), this slit being designed as an opening and extending substantially in a circumferential direction.

### FIELD OF THE INVENTION

The invention relates to a bearing arrangement for supporting a shaft on a connecting structure, the bearing arrangement comprising a backup bearing.

### BACKGROUND

In a bearing arrangement for supporting a shaft on a connecting structure the use of a backup bearing is known from experience, the backup bearing comprising a bearing ring, the bearing ring of the backup bearing forming a backup bearing gap with the shaft during the normal function of the bearing and in a load case, specifically in the event of failure of a bearing, comes into contact with the shaft. A housing with the bearing and the backup bearing is then fastened in the bore of a bearing support on a connecting structure. If the bearing—for example a magnetic bearing—fails, that is to say the load case occurs, the bearing ring of the backup bearing, which during the normal operation of the bearing includes the backup bearing gap in relation to the shaft, comes into contact with the shaft rotating at high speed, wherein high forces occur in the backup bearing which are concentrated on an only small section of the circumference of the bearing ring of the backup bearing. In this region, rolling elements or the running track of the bearing ring of the backup bearing can be damaged.

EP 1 395 759 B1 describes a bearing arrangement for supporting a shaft on a housing, comprising a magnetic bearing supporting the shaft, and a backup bearing, the bearing ring of the backup bearing including a backup bearing gap in relation to the shaft during the normal operation of the magnetic bearing. If the magnetic bearing fails, the shaft drops into an inner ring of the backup bearing. In order to avoid high axial and radial forces, a first intermediate element is fastened on the housing and a second intermediate element is fastened on an outer ring of the backup bearing, the second intermediate element having a radial groove in which engages a radial projection on the first intermediate element. Between the projection and the groove provision is made for damping elements which are to suppress a force transfer from the backup bearing to the rigid housing.

### SUMMARY

It is the object of the invention to disclose a bearing arrangement with a backup bearing, in which the forces which occur in the backup bearing in the load case can be absorbed in a better way.

For the bearing arrangement which is referred to in the introduction this object is achieved according to the invention by provision being made in the housing for a slot which extends essentially in the circumferential direction and is formed as a penetration.

The penetration extends essentially in the circumferential direction so that a curved slot is formed. The penetration is directed for example essentially parallel to the axis of the bearing between axially spaced apart end faces of the housing.

The penetration effects a material weakening so that the shaft, which drops into the backup bearing, brings about an elastic yielding of the material of the housing between the penetration of the curved slot and the bearing ring of the backup bearing. The bearing ring of the backup bearing, dropping into the housing, is locally cushioned in the process in an elastically sprung manner in the region of the slot in the load case. In particular, that surface section in the circumferential direction of the bearing ring of the backup bearing which bears the weight of the shaft is increased so that the weight of shaft which drops into the backup bearing is distributed over an increased surface region of the bearing ring of the backup bearing, as a result of which localized peak loads of the backup bearing are suppressed. The penetration, which extends only sectionally in the circumferential direction, especially reduces the rigidity of the bearing arrangement in a directed manner.

As a result of the elastic yielding of the material of the housing between the penetration and the shaft in the load case a so-called backward whirl can also be suppressed, that is to say a wandering of the shaft along the bearing ring of the backup bearing which faces the shaft, during which the shaft at high rotational speed moves along the inner generated surface of the inner bearing ring of the backup bearing. While moving along, the bearing ring of the backup bearing which faces the shaft experiences a high acceleration so that high forces and also a slip can occur in the backup bearing, which in each case could damage said backup bearing.

It is preferably provided that the penetration of the slot is produced by wire-guided electrical discharge machining, laser jet cutting or water jet cutting so that the penetration can be formed as a linearly extending penetration of only small gap width. The gap width of the slot in this case is typically less than approximately 2.0 millimeters, for example only approximately 0.25 millimeters, and basically corresponds to the amount of deflection of the backup bearing with the shaft in the housing in the load case.

It is preferably provided that the backup bearing has a load direction, and that the penetration extends essentially symmetrically to the load direction. The load direction corresponds, for example, to the direction of the gravity force. If two or more load directions are to be assumed, more than one penetration may be provided, especially a penetration for each load direction in each case, the penetrations being arranged in a staggered manner along the circumference and also radially with regard to the rotational axis of the shaft.

It is preferably provided that the sectionally provided penetration extends over a circumferential angle of between approximately 50° and approximately 180°, especially of approximately 120°. Due to the larger circumferential angle, in the load case the force is distributed over a plurality of rolling elements or over a larger circumferential section of the bearing ring of the backup bearing, wherein especially high forces of the load case which are to be anticipated are absorbed by a penetration which extends over a large circumferential angle.

It is preferably provided that the penetration has an essentially constant distance from a rotational axis of the bearing ring of the backup bearing, the penetration being formed as a circular arc. It is understood, however, that other progressions of the penetration in the circumferential direction can also be provided so that the penetration, in a plan view of the bearing arrangement in the direction of the rotational axis of the shaft, can be formed as a polygonal progression or as a sine wave, for example.

It is preferably provided that in an overload case the walls of the penetration butt against each other. In this case, the maximum possible elastic deformation is utilized but at the same time a damaging plastic deformation of the housing is avoided. In this case, a load case in which an exceptionally high increase of impact occurs is to be understood by an overload case.

It is preferably provided that a gap width of the penetration of the slot increases towards at least one end section of the penetration. As a result of the increase of the gap width of the slot, an occurrence of notch stresses at the ends of the slot, which could damage the housing in the load case, is prevented.

It is preferably provided that the penetration at at least one end section is curved away from the shaft. The curvature of the slot also brings about a prevention of notch stresses in the load case.

Further advantages and features are gathered from the dependent claims and also from the subsequent description of a preferred exemplary embodiment of the invention.

### BRIEF DESCRIPTION OF THE DRAWINGS

The invention is described and explained in more detail in the following text with reference to the attached drawings.

FIG. 1 shows a plan view of a housing which is part of an exemplary embodiment of a bearing arrangement according to the invention,

FIG. 2 shows in a detail a sectioned view of the housing from FIG. 1 along the line of intersection ‘A-A’ in FIG. 1, and

FIG. 3 shows the detail ‘A’ from FIG. 2 in enlarged view.

### DETAILED DESCRIPTION OF THE PREFERRED EMBODIMENTS

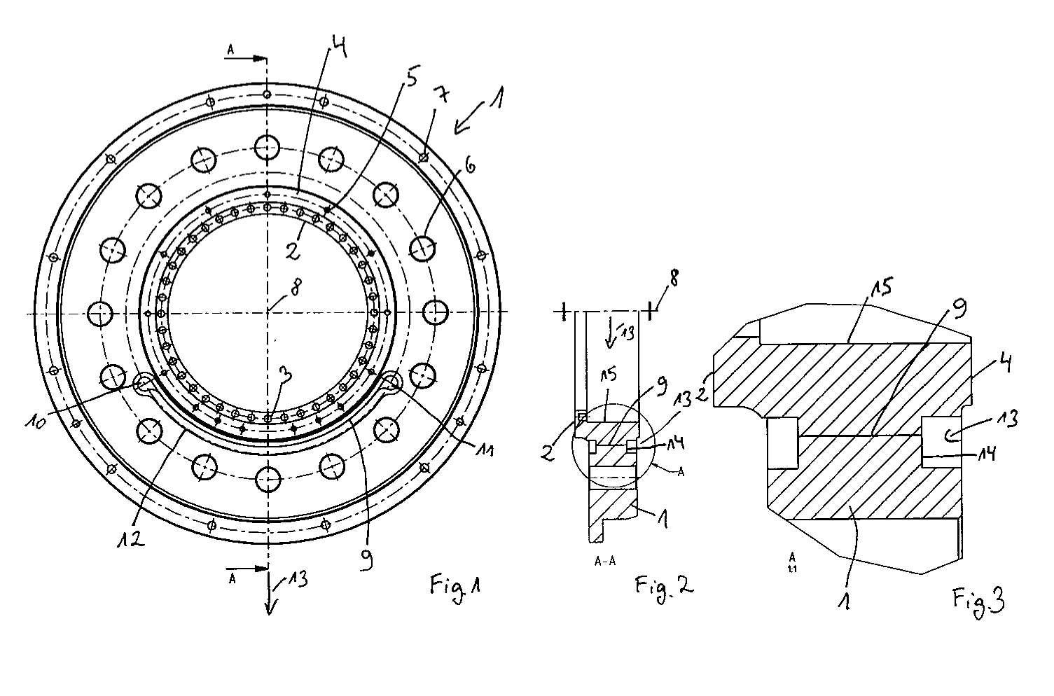

FIG. 1 shows a plan view of a housing 1 which is part of a bearing arrangement for the rotatable support of a shaft, which is not shown, on a connecting structure, which is not shown. In this case, an outer surface of the housing 1 is fastened in a bore of a bearing support. The shaft is rotatably supported in relation to the housing 1 and also in relation to the connecting structure by means of a bearing, especially by means of a magnetic bearing, which is not shown.

The bearing arrangement furthermore comprises a backup bearing, which is not shown, which is formed as a rolling bearing, the inner ring of which is fastened on the shaft and the outer ring of which includes a backup bearing gap in relation to an inner surface of the housing 1, provided that the supporting of the shaft is ensured by means of the magnetic bearing. If the magnetic bearing fails, that is to say the load case occurs, the shaft drops under its own weight into the backup bearing so that the backup bearing is pressed by the outer ring onto an inner surface 15 of the housing 1 (FIGS. 2, 3), which in this case supports the shaft at least temporarily.

The basically circular housing 1 has a rear section 2 which is arranged beneath the plane of the paper, wherein in the rear section 2 provision is made for a circumferential sequence of blind holes, of which one is provided with the designation ‘3’. Fastened in the blind holes 3 are springs which act upon the outer ring of the backup bearing in the axial direction, that is to say in a direction which is perpendicular to the plane of the paper, so that the backup bearing, which is designed as a double-row angular-contact ball bearing with common inner ring for both running tracks of the spherical rolling elements, is mechanically pretensioned. The housing 1 has a front section 4, located above the plane of the paper, in which provision is made for a similarly circumferential sequence of holes, of which one is identified by the designation ‘5’, the holes 5 being formed for the fastening of a cover. In the region of the front section 4, provision is furthermore made for a circumferential sequence of ventilation holes, of which one is identified by the designation ‘6’, and also a circumferential sequence of fastening holes for the fastening of the housing 1 on the connecting structure, one of the fastening holes being identified by the designation ‘7’.

The circumferential sequence of the holes 5, of the ventilation holes 6, of the fastening holes 7 of the front section 4 and also of the blind holes 3 of the rear section 2 of the housing 1 is oriented in each case concentrically to a symmetry axis 8, the symmetry axis 8 corresponding to the rotational axis of the shaft during normal, undisturbed operation of the magnetic bearing, and also corresponding to the rotational axis of the backup bearing.

In the body of the housing 1, provision is made for a slot 9 which extends only sectionally in the circumferential direction of the circular housing 1 and is formed as a penetration, the penetration being directed parallel to the axis 8, that is to say also parallel to the rotational axis of the magnetic bearing or of the backup bearing and, as a result, perpendicularly to the plane of the paper in FIG. 1.

The slot 9 extends over a third of a circle, that is to say over a circumferential angle of 120°, the penetration of the slot 9 being produced by means of wire-guided electrical discharge machining (alternatively to this by means of laser jet cutting or water jet cutting, for example). The circumferential angle of the slot 9 could also assume other values, for example a value of between approximately 50° and approximately 180°.

The slot 9 has two end sections 10, 11, towards which a gap width of the penetration, that is to say of the distance between the opposite sides of the penetration, increases. The gap width of the slot 9, over a length of approximately 95% of the extent in the circumferential direction, is approximately 0.2 millimeters and increases significantly towards the end sections 10, 11. Due to the only small gap width of approximately 0.2 millimeters, in an overload case, that is to say in a load case with a very high increase of impact, the walls of the penetration of the slot 9 butt against each other and therefore the slot 9 is blocked. When the penetration of the slot 9 is being produced, for example by wire-guided electrical discharge machining, the eroding wire is guided back at the end sections 10, 11 in an arc towards the already produced slot section so that an approximately cylindrical material piece with a basically teardrop-shaped cross-sectional profile is cut out from the body of the housing 1. It is understood that one of the two end sections 10, 11 can be provided as an entry hole for the wire, for example as a hole into which the eroding wire is inserted. It is also understood that the wire can be guided back only incompletely when the wire-guided electrical machining is being carried out so that the result is a curved gap, pointing away from the axis 8, which widens only slightly at the end sections.

The penetration of the slot 9 is formed inside a recess 12 so that the removal of material is reduced when the penetration is being formed.

The bearing arrangement with the backup bearing and the housing 1 has a preferred load direction which is provided by the direction of the gravity force acting upon the shaft and which in the view of FIG. 1 acts in the direction of the line of intersection A-A in the direction of the arrow 13. The slot 9 with the penetration is formed symmetrically with regard to this load direction 13.

The penetration of the slot 9 has a constant distance from the rotational axis 8 of the bearing ring of the backup bearing during normal operation of the magnetic bearing so that the slot 9 with the penetration is formed as a circular arc.

FIG. 2 and FIG. 3 show in each case the housing 1 from FIG. 1 in a detail in a view sectioned along the line A-A. The penetration of the slot 9 is realized from the bottom 14 of the recess 12 to a bottom of a recess on the axially opposite side of the housing 1 with regard to the axis 8 and is guided parallel to the axis 8 and also perpendicularly to the load direction 13.

In the case of the previously described exemplary embodiment, in an overload case the walls of the penetration of the slot 9, lying opposite with regard to the axis 8, butt against each other. It is understood that provision can be made in the penetration for a filling material, for example a flexible film, which reduces the gap width of the slot or the space between the opposite walls, or a fluid which fills out the gap of the slot, the filling material absorbing the forces which occur in the load case.

In the case of the previously described exemplary embodiment, it was assumed that the backup bearing gap between the outer ring of the rolling bearing and the inner surface of the housing 1 is basically free. It is understood that a corrugated spring can be arranged between the bearing ring of the backup bearing and the housing 1, the corrugated spring at least partially absorbing the forces which occur in the load case and being distributed over a larger surface section of the housing.

In the case of the previously described exemplary embodiment, the penetration of the slot 9 was formed as a circular arc which was also provided in the end sections 10, 11. It is understood that the slot in the end sections 10, 11 can have a curvature pointing away from the shaft or from the axis 8 and in this respect can deviate from the contour of a circular arc.

Differing from the previously described exemplary embodiment, the slot can also have a progression in the circumferential direction of the housing 1 which deviates from a circular arc, for example the distance from the axis 8 can periodically vary in the circumferential direction so that the slot has a sine-shaped progression, for example. Again, alternatively to a periodic progression in the circumferential direction, the slot can be formed as a polygonal progression.

### LIST OF REFERENCE NUMBERS

1. Housing
2. Rear section of the housing 1
3. Blind hole
4. Front section of the housing 1
5. Hole
6. Ventilation hole
7. Fastening hole
8. Axis
9. Slot
10. End section
11. End section
12. Recess
13. Load direction (arrow)
14. Bottom
15. Inner surface of the housing 1

1. A bearing arrangement for supporting a shaft on a connecting structure, comprising
a housing,
a bearing supporting the shaft, and
a backup bearing,
the backup bearing comprises a bearing ring which comes into contact with the housing, and
in the housing a slot which extends essentially in a circumferential direction and is formed as a penetration.

2. The bearing arrangement, claim 1, wherein the backup bearing has a load direction, and the penetration of the slot extends essentially symmetrically to the load direction.

3. The bearing arrangement as claimed in claim 1, wherein the slot extends over a circumferential angle of between approximately 50° and approximately 180°.

4. The bearing arrangement as claimed in claim 1, wherein the penetration has an essentially constant distance from a rotational axis of the bearing ring of the backup bearing, and the penetration is formed as a circular arc.

5. The bearing arrangement as claimed in claim 1, wherein in an overload case the walls of the penetration butt against each other.

6. The bearing arrangement as claimed in claim 1, wherein a gap width of the penetration of the slot increases towards at least one end section of the penetration.

7. The bearing arrangement as claimed in claim 1, wherein the penetration is curved away from the shaft at end sections thereof.

8. The bearing arrangement as claimed in claim 1, wherein the penetration of the slot is a wire-guided electrical discharge machined, laser jet or water jet cut penetration.

9. The bearing arrangement as claimed in claim 1, wherein a corrugated spring is arranged between the bearing ring of the backup bearing and the housing.
